(19) United States
(12) Patent Application Publication
(10) Pub. No.: US 2017/0107757 A1
(43) Pub. Date: Apr. 20, 2017

(54) WINDOW BLIND

(71) Applicant: Shanghai Kingshine Plastic Manufacture Co., Ltd., Shanghai City (CN)

(72) Inventors: Szu-Chang HUANG, Taiwan (CN); Patrick HOOPER, Mercer Island, WA (US)

(21) Appl. No.: 15/069,823

(22) Filed: Mar. 14, 2016

(30) Foreign Application Priority Data
Oct. 14, 2015 (CN) 201520792674.X

(51) Int. Cl. E06B 9/264; E06B 9/386

(52) U.S. Cl. CPC E06B 9/264; E06B 9/386; E06B 2009/2643; E06B 2009/2646

(57) ABSTRACT

A window blind includes an outer framework and a blind unit. The outer framework defines a retaining space therein, and has two open grooves in spatial communication with the retaining space. The blind unit includes a plurality of slats and two ladder strings. Each of the slats has an intermediate portion, and two end portions respectively extending into the open grooves of the outer framework. Each of the ladder strings is retained in a respective one of the open grooves, and interconnects the corresponding end portions of the slats retained in the respective one of the open grooves.

### CROSS-REFERENCE TO RELATED APPLICATION

This application claims priority of Chinese Application No. 201520792674.X, filed on Oct. 14, 2015.

### FIELD

The disclosure relates to a window blind, and more particularly to a window blind that has hidden ladder strings.

### BACKGROUND

As shown in FIGS. 1 and 2, a conventional window blind includes an outer framework 1, a plurality of slats 2, a lower rail 3, two ladder strings 4, two pull cords (not shown), two glass panes (not shown), and a control system 5. The outer framework 1 is disposed between the glass panes, and includes an upper frame 101, a lower frame 102, and two side frames 103 that cooperate with the upper frame 101 and that lower frame 102 to define a retaining space 104. The width of an inner wall section of each of the side frames 103 ranges from 5 millimeters to 7 millimeters. Each of the ladder strings 4 interconnects the slats 2 and the lower rail 3. Each of the slats 2 has two through holes (not shown) that are respectively formed in two opposite end portions thereof. For each of the slats 2, a distance between each of the through holes and a distal end of the corresponding end portion ranges from 40 millimeters to 120 millimeters. The pull cords respectively extend through the through holes of each of the slats 2, and are connected to the lower rail 3. Each of the slats 2 has an arc height ranging from 0.9 millimeters to 1.1 millimeters. The slats 2 and the lower rail 3 are disposed in the retaining space 104, and are disposed between the side frames 103. The control system 5 is operable to raise or lower the lower rail 3 via the pull cords, and to control the angle of each of the slats 2 via the ladder strings 4.

The conventional window blind has the following drawbacks:

1. When the lower rail 3 is raised such that the slats 2 are stacked on the lower rail 3, each of the ladder strings 4 is curled so as to contact an inner surface of each of the glass panes. The curled portion of each of the ladder strings 4 may easily scratch an UV (ultraviolet) coating formed on the inner surface of each of the glass panes, and even scratch the glass panes.

2. Since the distance between each of the through holes of the slats 2 and the distal end of the corresponding end portion is greater than the width of the inner wall section of each of the side frames 103 of the outer framework 1, the through holes cannot be covered by the side frames 103 of the outer framework 1. When the angle of each of the slats 2 is adjusted for obstructing light, light can still pass through the through holes of the slats 2.

3. Similar to the above, the ladder strings 4 and the pull cords cannot be covered by the inner wall section of each of the side frames 103 of the outer framework 1, so that the conventional window blind is not visually esthetic.

### SUMMARY

Therefore, an object of the disclosure is to provide a window blind that can overcome at least one of the aforesaid drawbacks associated with the prior art.

According an aspect of the disclosure, the window blind includes an outer framework and a blind unit. The outer framework includes an upper frame that extends in a first direction, a lower frame that is spaced apart from the upper frame in a second direction transverse to the first direction, and two side frames each of which is connected between a respective one of two opposite ends of the upper frame and a corresponding one of two opposite ends of the lower frame, and is spaced apart from the other one of the side frames in the first direction. The upper frame, the lower frame and the side frames cooperatively define a retaining space there among. Each of the side frames has an open groove that extends in the second direction and that has an opening in spatial communication with the retaining space. The retaining space and the open grooves of the side frames cooperatively form an operation space. The blind unit includes a plurality of slats that are disposed in the operation space and that are arranged in the second direction, and two ladder strings. Each of the slats extends in the first direction, and has an intermediate portion that is retained in the retaining space, and two end portions that respectively extend from two opposite ends of the intermediate portion into the open grooves of the side frames. Each of the ladder strings is retained in a respective one of the open grooves, and interconnects the corresponding end portions of the slats that are retained in the respective one of the open grooves. The ladder strings are respectively covered by the side frames. The end portions of each of the slats are respectively covered by the side frames.

According to another aspect of the disclosure, the window blind includes an outer framework, a blind unit disposed in the outer framework, and an operation unit disposed on the outer framework and operably connected to the blind unit. The outer framework includes two spaced-apart light-transmissive plates. The blind unit includes a plurality of slats each of which extends in a first direction, and two ladder strings. The slats are arranged in a second direction transverse to the first direction. Each of the ladder strings extends in the second direction and interconnects the slats. The outer framework further includes a cover unit that is disposed on the light-transmissive plates, and that covers the ladder strings.

### BRIEF DESCRIPTION OF THE DRAWINGS

Other features and advantages of the disclosure will become apparent in the following detailed description of the embodiments with reference to the accompanying drawings, of which:

FIG. 1 is a schematic side view of a conventional window blind;

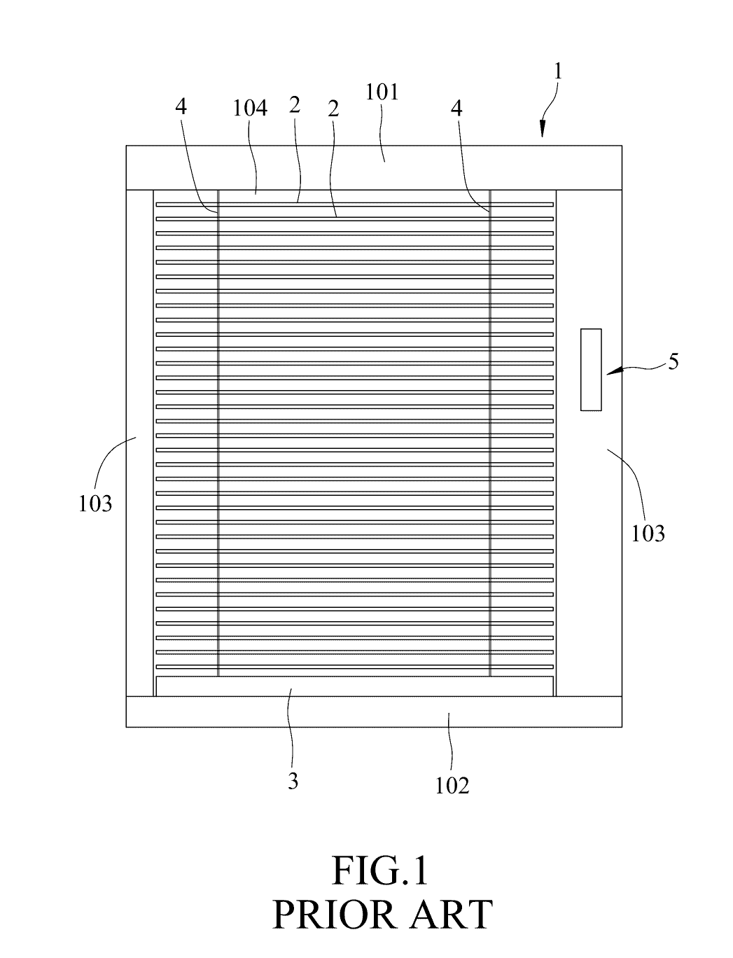

FIG. 2 is another schematic side view of the conventional window blind;

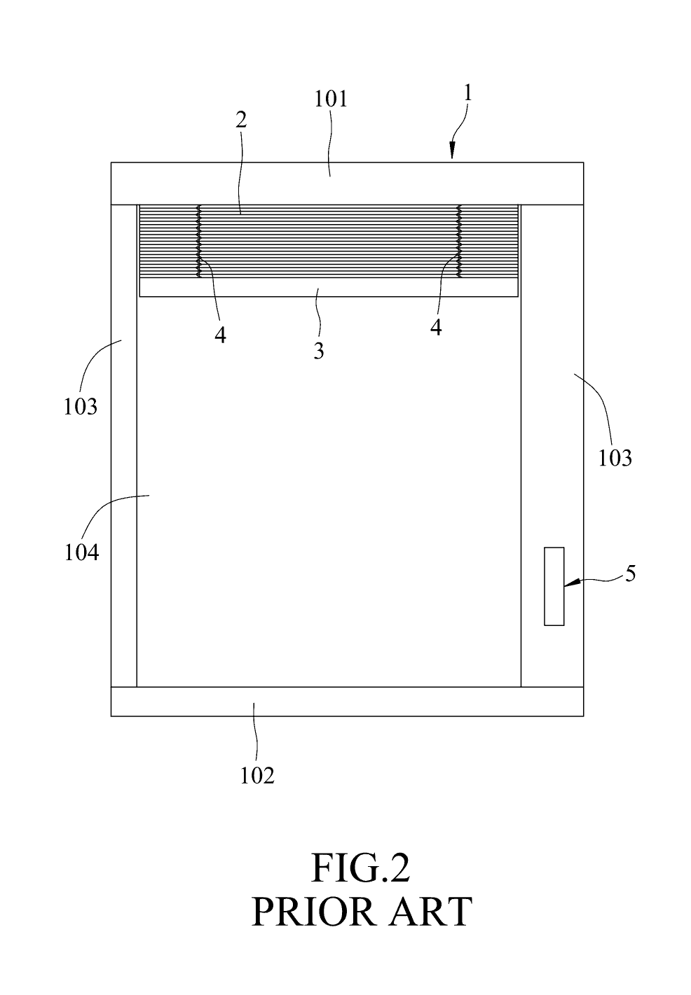

FIG. 3 is a schematic side view of a first embodiment of the window blind according to the disclosure;

FIG. 4 is a fragmentary perspective view of the first embodiment;

FIG. 5 is a sectional view taken along line V-V in FIG. 3;

FIG. 6 is another schematic side view of the first embodiment;

FIG. 7 is another sectional view taken along line VII-VII in FIG. 6;

FIG. 8 is a sectional view of a slat of the first embodiment;

FIG. 9 is a schematic side view of a second embodiment of the window blind according to the disclosure; and

FIG. 10 is a sectional view taken along line X-X in

[symbol]

### DETAILED DESCRIPTION

Before the disclosure is described in greater detail, it should be noted that like elements are denoted by the same reference numerals throughout the disclosure.

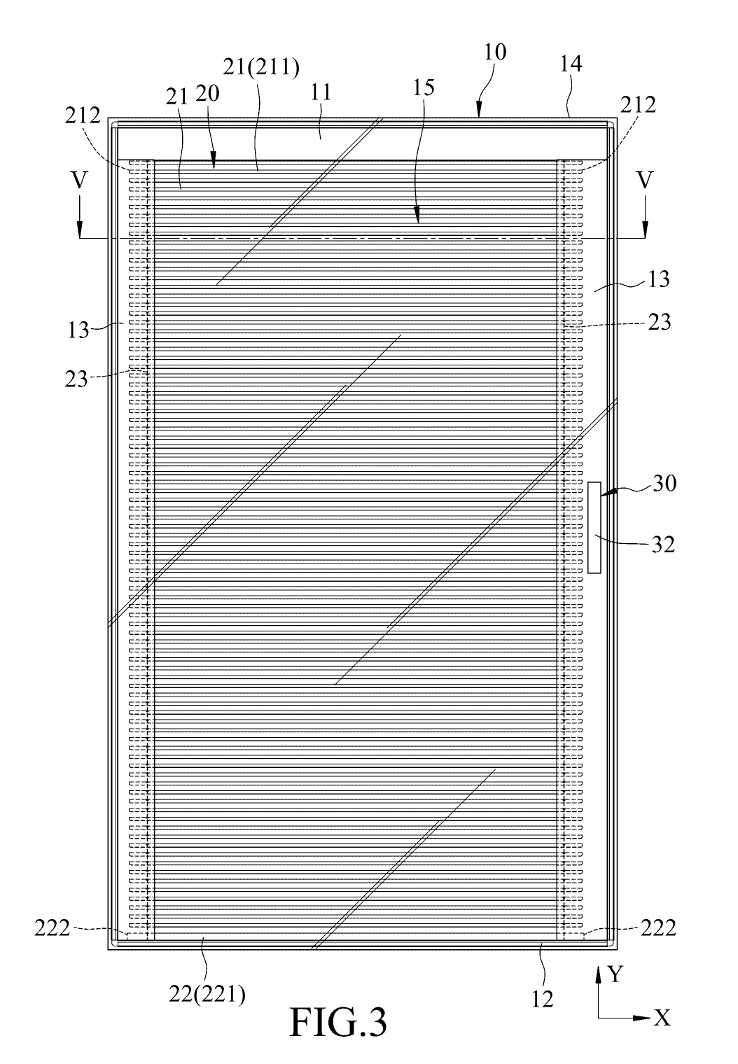

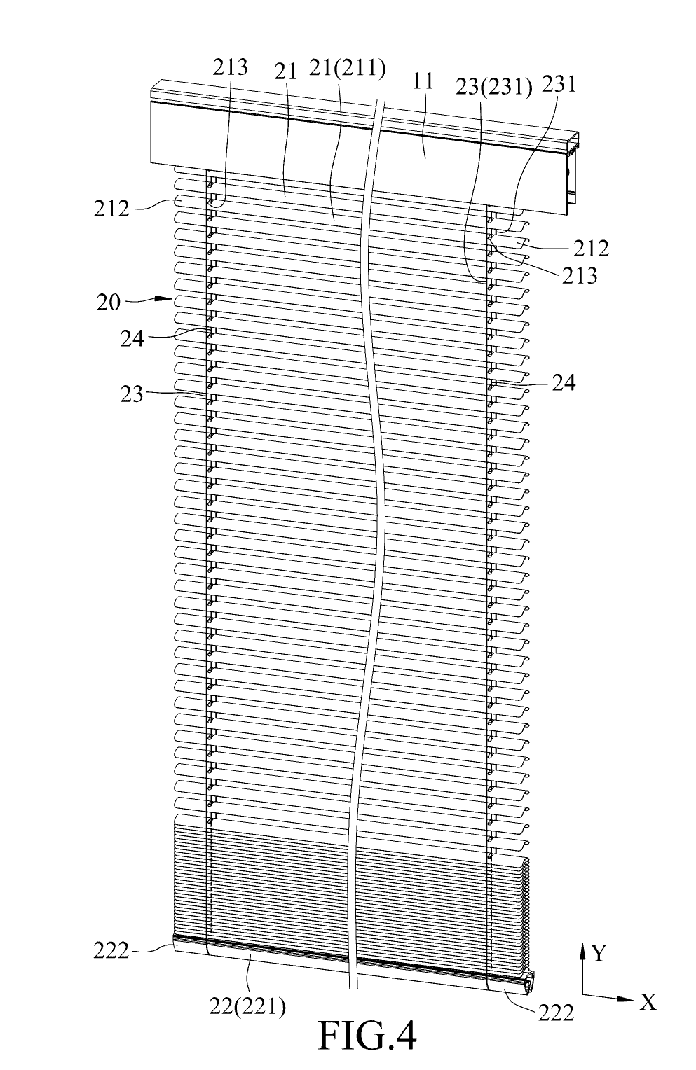

Referring to FIGS. 3 to 5, a first embodiment of the window blind according to the disclosure includes an outer framework 10, a blind unit 20 disposed in the outer framework 10, and an operation unit 30 disposed on the outer framework 10 and operably connected to the blind unit 20.

The outer framework 10 includes an upper frame 11 that extends in a first direction (X), a lower frame 12 that is spaced apart from the upper frame 11 in a second direction (Y) transverse to the first direction (X), two side frames 13 each of which is connected between a respective one of two opposite ends of the upper frame 11 and a corresponding one of two opposite ends of the lower frame 12, and is spaced apart from the other one of the side frames 13 in the first direction (X), and two spaced-apart light-transmissive plates 14. The upper frame 11, the lower frame 12 and the side frames 13 are disposed between the light-transmissive plates 14, and cooperatively define a retaining space 15 there among.

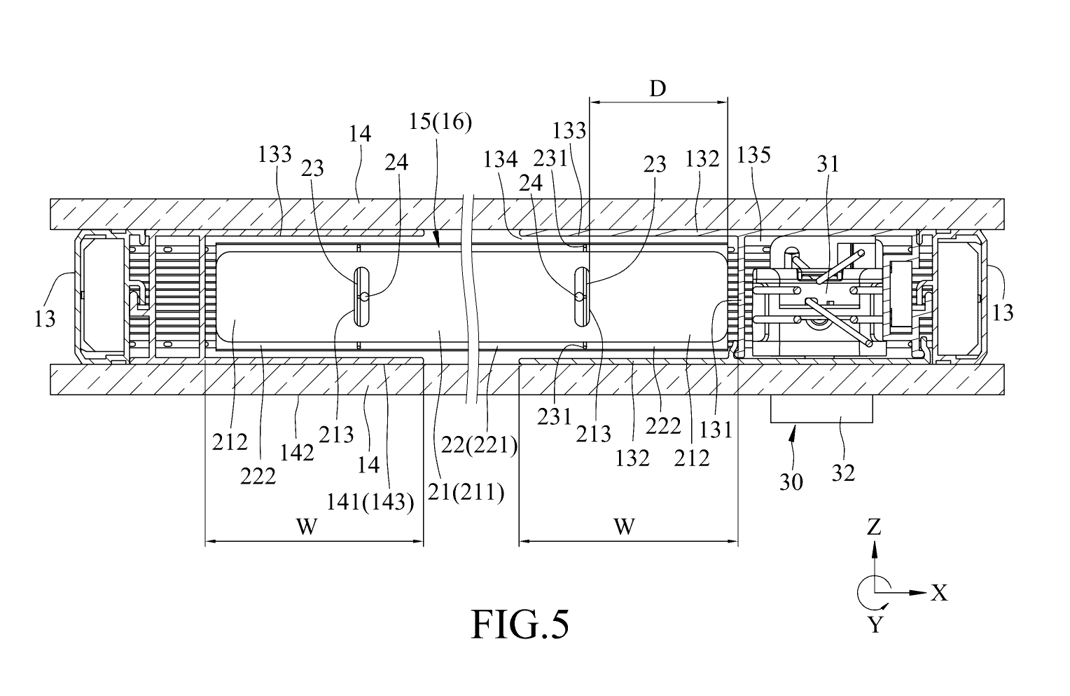

Each of the side frames 13 has a base wall section 131, two side wall sections 132 that respectively extend from two opposite edges of the base wall section 131 opposite to each other in a third direction (Z) (see FIG. 5) that is transverse to the first and second directions (X, Y) toward the other one of the side frames 13, and an open groove 133 that is defined among the base wall section 131 and the side wall sections 132. The open groove 133 of each of the side frames 13 has an opening 134 that is in spatial communication with the retaining space 15. The retaining space 15 and the open grooves 133 of the side frames 13 cooperatively form an operation space 16. In this embodiment, one of the side frames 13 (i.e. the right one in FIG. 5) further has an operation groove 135 that is spaced apart from the open groove 133 thereof, and that extends in the second direction (Y). The width (W) of each of the side wall sections 132 of each of the side frames 13 in the first direction (X) ranges from 25 millimeters to 35 millimeters.

Each of the light-transmissive plates 14 has an inner surface 141 that faces the other one of the light-transmissive plates 14, an outer surface 142 that is opposite to the inner surface 141, and an UV coating 143 that is formed on the inner surface 141. The upper frame 11, the lower frame 12 and the side frames 13 are braced between the inner surfaces 141 of the light-transmissive plates 14. In this embodiment, each of the light-transmissive plates 14 is configured as a glass pane.

The blind unit 20 includes a plurality of slats 21 that are disposed in the operation space 16 and that are arranged in the second direction (Y), a lower rail 22 that is disposed in the operation space 16 and that is disposed under the slats 21, two ladder strings 23, and two pull cords 24.

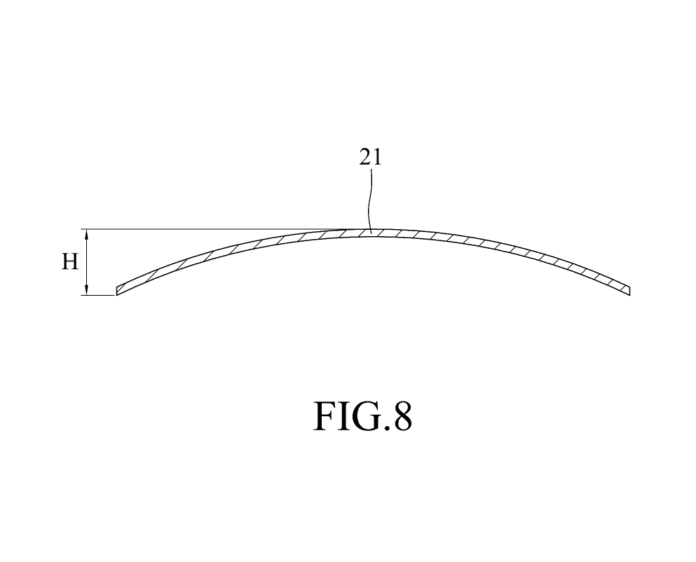

Each of the slats 21 extends in the first direction (X), and has an intermediate portion 211 that is retained in the retaining space 15, and two end portions 212 that respectively extend from two opposite ends of the intermediate portion 211 into the open grooves 133 of the side frames 13. Each of the end portions 212 of each of the slats 21 has a through hole 213. In this embodiment, each of the slats 21 has an arc height (H, see FIG. 8) ranging from 1.2 millimeters to 1.6 millimeters. For each of the slats 21, the stiffness thereof increases with the increasing arc height thereof. For each of the slats 21, a distance (D) between each of the through holes 213 and a distal end of the corresponding end portion 212 ranges from 15 millimeters to 25 millimeters.

The lower rail 22 has an intermediate segment 221 that is retained in the retaining space 15, and two end segments 222 that respectively extend from two opposite ends of the intermediate segment 221 into the open grooves 133 of the side frames 13.

Each of the ladder strings 23 is retained in a respective one of the open grooves 133 of the side frames 13, and interconnects the corresponding end segment 222 of the lower rail 22 and the corresponding end portion 212 of each of the slats 21.

The pull cords 24 interconnect the slats 21 and the lower rail 22. In this embodiment, each of the pull cords 24 is retained in a respective one of the open grooves 133 of the side frames 13, extends through the through hole 213 of the corresponding end portion 212 of each of the slats 21, and is connected to the corresponding end segment 222 of the lower rail 22.

In this embodiment, the end portions 212 of each of the slats 21 are respectively covered by the side frames 13, the end segments 222 of the lower rail 22 are respectively covered by the side frames 13, the ladder strings 23 are respectively covered by the side frames 13, and the pull cords 24 are respectively covered by the side frames 13.

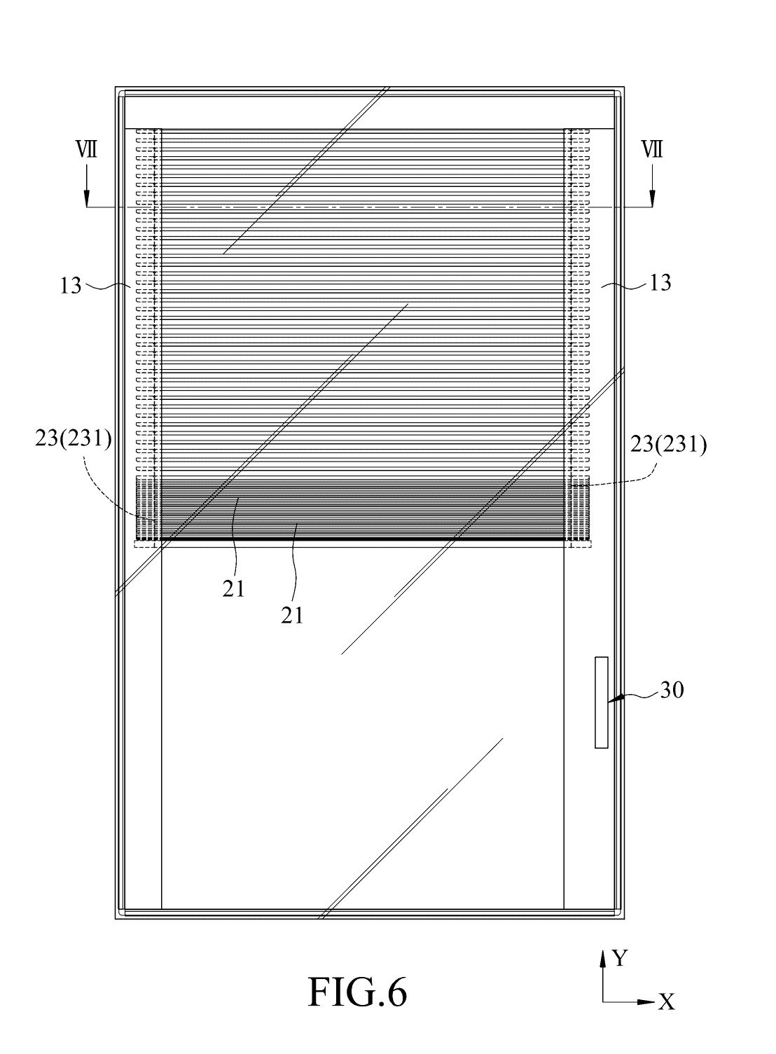

The operation unit 30 includes an interior operating member 31 that is operably disposed in the operation groove 135 of the one of the side frames 13, and an exterior operating member 32 that is operably disposed on the outer surface 142 of one of the light-transmissive plates 14. The interior operating member 31 is operably connected to the ladder strings 23 and the pull cords 24. The exterior operating member 32 is magnetically coupled to the interior operating member 31. Movement of the exterior operating member 32 drives the interior operating member 31 to adjust the angle of each of the slats 21 via the ladder strings 23, and to raise or lower the lower rail 22 via the pull cords 24 (see FIGS. 3 and 6). The configuration among the ladder strings 23, the pull cords 24 and the operation unit 30 is known in the art, and will not be described in the following paragraphs.

By virtue of the configuration of the first embodiment, the end portions 212 of each of the slats 21, the end segments 222 of the lower rail 22, the ladder strings 23 and the pull cords 24 are operably retained in the open grooves 133 of the side frames 13, and are hidden by the side frames 13.

The advantages of this disclosure are as follows.

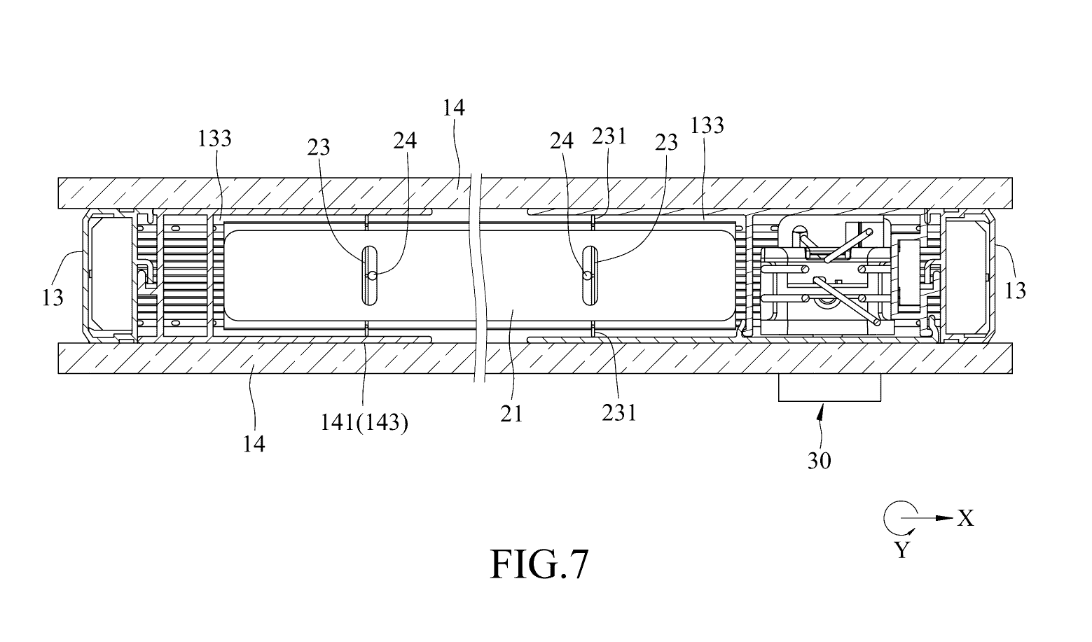

1. Referring to FIGS. 6 and 7, when the lower rail 22 is raised to stack the slats 21 thereon, each of the ladder strings 23 is curled. However, curled portions 231 (see FIG. 7) of each of the ladder strings 23 are retained within the corresponding open groove 133, and are prevented from contacting the inner surfaces 141 of the light-transmissive plates 14. As a result, the UV coating of each of the light-transmissive plates 14 are prevented from being scratched, and the light-transmissive plates 14 are also prevented from being scratched.

2. Since the end portions 212 of each of the slats 21 are respectively retained in the open grooves 133 of the side frames 13, the through holes 213 of each of the slats 21 are respectively covered by the side frames 13. When the angle of each of the slats 21 are adjusted for obstructing light, light is blocked from passing through the through holes 213 of the slats 21.

3. Since the end portions 212 of each of the slats 21, the end segments 222 of the lower rail 22, the ladder strings 23 and the pull cords 24 are hidden by the side frames 13, the window blind of this disclosure is visually esthetic.

4. In this embodiment, the arc height (H) of each of the slats 21 is greater than that of the abovementioned prior art for enhancing the stiffness of the slats 21, so that each of slats 21 may have a relatively large length in the first direction (X).

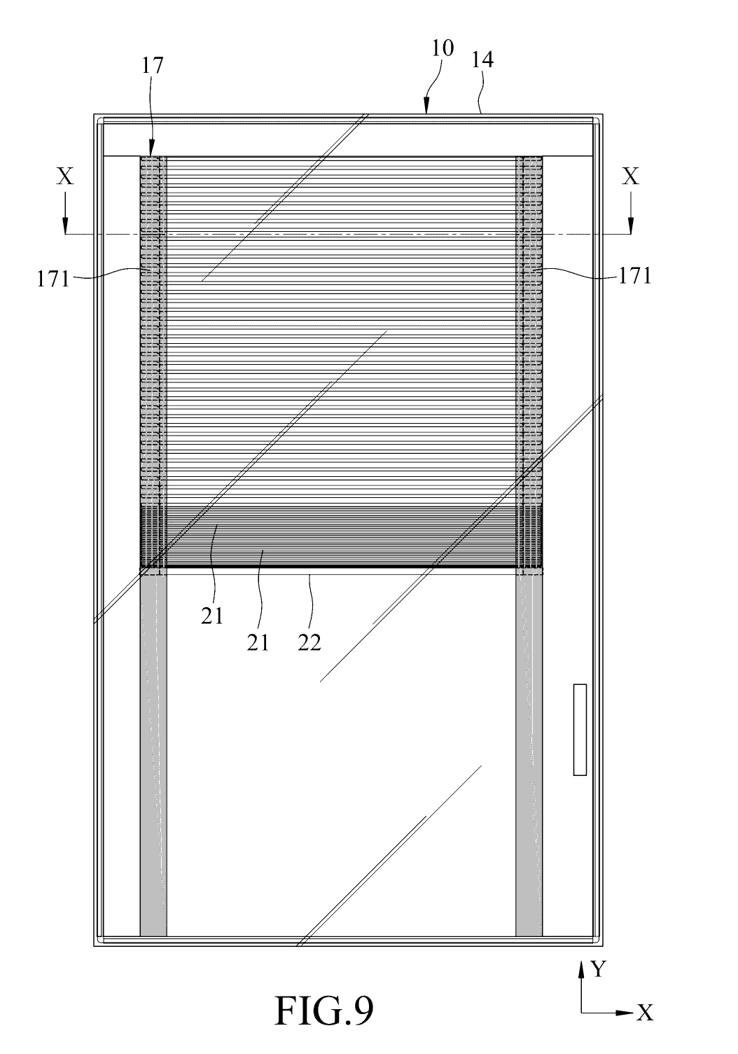

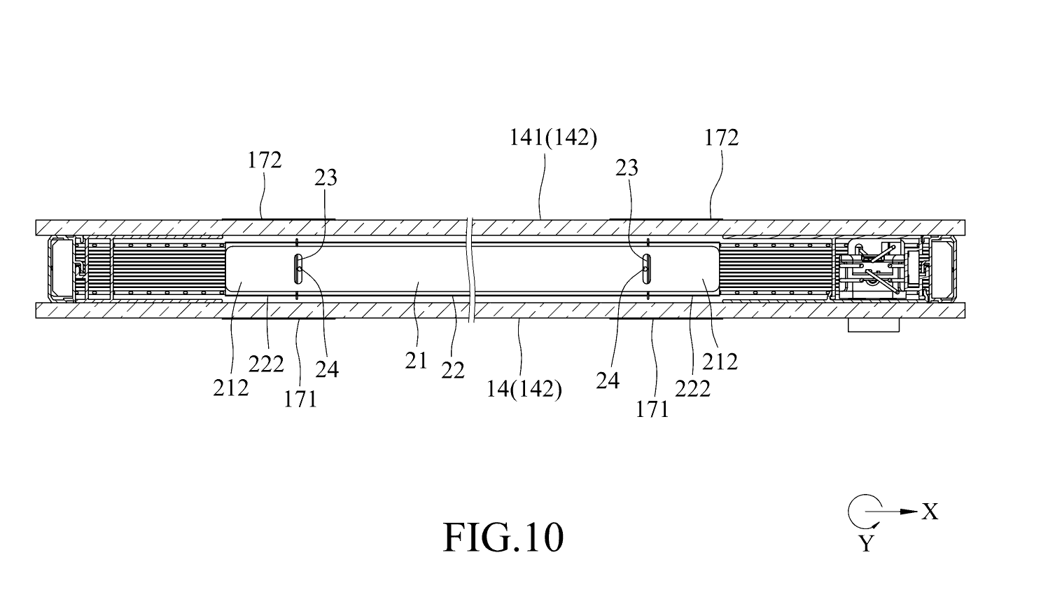

FIGS. 9 and 10 illustrate a second embodiment of the window blind according to the disclosure.

The outer framework 10 further includes a cover unit 17 that is disposed on the light-transmissive plates 14. The slats 21, the lower rail 22, the ladder strings 23 and the pull cords 24 are retained in the retaining space 15.

The cover unit 17 includes two spaced-apart first covering coatings 171 that are disposed on the outer surface 142 of one of the light-transmissive plates 14, and two spaced-apart second covering coatings 172 that are disposed on the outer surface 142 of the other one of the light-transmissive plates 14. Each of the first covering coatings 171 extends in the second direction (Y), and covers a respective one of the end portions 212 of each of the slats 21, a respective one of the end segments 222 of the lower rail 22, a respective one of the ladder strings 23 and a respective one of the pull cords 24. Each of the second covering coatings 172 extends in the second direction (Y), and covers a respective one of the end portions 212 of each of the slats 21, a respective one of the end segments 222 of the lower rail 22, a respective one of the ladder strings 23 and a respective one of the pull cords 24.

Since the end portions 212 of each of the slats 21, the end segments 222 of the lower rail 22, the ladder strings 23 and the pull cords 24 are hidden by the cover unit 17, the second embodiment is visually esthetic.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A window blind comprising:
an outer framework including an upper frame that extends in a first direction, a lower frame that is spaced apart from said upper frame in a second direction transverse to the first direction, and two side frames each of which is connected between a respective one of two opposite ends of said upper frame and a corresponding one of two opposite ends of said lower frame, and is spaced apart from the other one of said side frames in the first direction, said upper frame, said lower frame and said side frames cooperatively defining a retaining space there among, each of said side frames having an open groove that extends in the second direction and that has an opening in spatial communication with said retaining space, said retaining space and said open grooves of said side frames cooperatively forming an operation space; and
a blind unit including a plurality of slats that are disposed in said operation space and that are arranged in the second direction, and two ladder strings, each of said slats extending in the first direction, and having an intermediate portion that is retained in said retaining space, and two end portions that respectively extend from two opposite ends of said intermediate portion into said open grooves of said side frames, each of said ladder strings being retained in a respective one of said open grooves, and interconnecting the corresponding end portions of said slats that are retained in the respective one of said open grooves, said ladder strings being respectively covered by said side frames, said end portions of each of said slats being respectively covered by said side frames.

2. The window blind as claimed in claim 1, wherein said blind unit further includes a lower rail that is disposed in said operation space and that is disposed under said slats, and two pull cords, each of said end portions of each of said slats having a through hole, said lower rail having an intermediate segment that is retained in said retaining space, and two end segments that respectively extend from two opposite ends of said intermediate segment into said open grooves of said side frames, said ladder strings being respectively connected to said end segments of said lower rail, each of said pull cords being retained in a respective one of said open grooves of said side frames, extending through said through hole of said corresponding end portion of each of said slats, and being connected to said corresponding end segment of said lower rail, said pull cords being respectively covered by said side frames, said end segments of said lower rail being respectively covered by said side frames.

3. The window blind as claimed in claim 2, wherein each of said side frames has a base wall section that extends in the second direction, two side wall sections that respectively extend from two opposite edges of said base wall section opposite to each other in a third direction that is transverse to the first and second directions toward the other one of said side frames, and that cooperate with said base wall section to define said open groove of said corresponding side frame.

4. The window blind as claimed in claim 3, wherein a width of each of said side wall sections of each of said side frames in the first direction ranges from 25 millimeters to 35 millimeters.

5. The window blind as claimed in claim 4, wherein, for each of said slats, a distance between each of said through holes thereof and a distal end of said corresponding end portion ranges from 15 millimeters to 25 millimeters.

6. The window blind as claimed in claim 5, wherein each of said slats has an arc height ranging from 1.2 millimeters to 1.6 millimeters.

7. The window blind as claimed in claim 2, wherein said outer framework further includes two spaced-apart light-transmissive plates, each of said light-transmissive plates having an inner surface that faces the other one of said light-transmissive plates, an outer surface that is opposite to said inner surface, said upper frame, said lower frame and said side frames being disposed between said inner surfaces of said light-transmissive plates.

8. The window blind as claimed in claim 7, wherein one of said side frames further has an operation groove that is spaced apart from said open groove thereof and that extends in the second direction, said operation unit including an interior operating member that is operably disposed in said operation groove of the one of said side frames, and an exterior operating member that is operably disposed on said outer surface of one of said light-transmissive plates, said interior operating member being operably connected to said ladder strings and said pull cords, said exterior operating member being magnetically coupled to said interior operating member.

9. The window blind as claimed in claim 7, wherein each of said light-transmissive plates further has an UV coating that is formed on said inner surface thereof.

10. A window blind comprising:
an outer framework;
a blind unit disposed in said outer framework; and
an operation unit disposed on said outer framework and operably connected to said blind unit, said outer framework including two spaced-apart light-transmissive plates, said blind unit including a plurality of slats each of which extends in a first direction, and two ladder strings, said slats being arranged in a second direction transverse to the first direction, each of said ladder strings extending in the second direction and interconnecting said slats, said outer framework further including a cover unit that is disposed on said light-transmissive plates, and that covers said ladder strings.

11. The window blind as claimed in claim 10, wherein each of said light-transmissive plates has an outer surface that faces away from the other one of said light-transmissive plates, said cover unit including two spaced-apart first covering coatings that are disposed on said outer surface of one of said light-transmissive plates, and two spaced-apart second covering coatings that are disposed on said outer surface of the other one of said light-transmissive plates, each of said first covering coatings extending in the second direction, and covering a respective one of said ladder strings, each of said second covering coatings extending in the second direction, and covering a respective one of said ladder strings.
